(19) United States
(12) Patent Application Publication
(10) Pub. No.: US 2012/0069218 A1
(43) Pub. Date: Mar. 22, 2012

(54) VIRTUAL VIDEO CAPTURE DEVICE

(75) Inventor: Alexander Gantman, Poway, CA (US)

(73) Assignee: QUALCOMM Incorporated, San Diego, CA (US)

(21) Appl. No.: 12/886,425

(22) Filed: Sep. 20, 2010

(51) Int. Cl. H04N 5/225

(52) U.S. Cl. 348/231.99; 348/E05.024

(57) ABSTRACT

Systems and methods for setting up and running a virtual video capture device are described herein. The virtual video capture device may receive image data and output the data in a format similar to a video capture device. The virtual video capture device may operate with an application configured to receive data from a physical video capture device.

### BACKGROUND

1. Field

The present application relates generally to video capture devices, and more specifically to systems and methods for implementing a virtual video capture device.

2. Background

Many applications are designed to work in conjunction with a standard video capture device such as a webcam to stream video and/or audio over a network from one device to another device. Accordingly, users of the devices can participate in videophone calls or video conferencing. The applications are typically setup to specifically take video from the webcam and transmit the video. In other words, the applications are designed to specifically work with the drivers of a webcam and video formats used by a webcam in order to transmit video. Accordingly, the applications are limited to transmitting video input that is captured by the webcam, such as real-time video of a user of the webcam.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include systems and method for implementing a virtual video capture device.

One embodiment of the disclosure provides a video display apparatus comprising a processor. The video display apparatus further comprises a memory in communication with the processor. The memory comprises instructions. The instructions when executed by the processor cause the processor to execute a program that is configured to receive video input from at least one physical video capture device. The instructions when executed by the processor further cause the processor to execute a virtual video capture device. The virtual video capture device is configured to retrieve the image data. The virtual video capture device is further configured to transcode the retrieved image data. The virtual video capture device is configured output the transcoded image data for use by the program. The instructions when executed by the processor further cause the processor to register the virtual video capture device as a first physical video capture device with an operating system, wherein the operating system controls execution of the program.

Another embodiment of the disclosure provides a method of processing data for a program configured to receive video input from at least one physical video capture device. The method comprises executing a program that is configured to receive video input from at least one physical video capture device. The method further comprises executing a virtual video capture device. Executing the virtual video capture device comprises retrieving the image data. Executing the virtual video capture device further comprises transcoding the retrieved image data. Executing the virtual video capture device further comprises outputting the transcoded image data for use by the program. The method further comprises registering the virtual video capture device as a first physical video capture device with an operating system, wherein the operating system controls execution of the program.

Yet another embodiment of the disclosure provides a video display apparatus comprising means for executing a program that is configured to receive video input from at least one physical video capture device. The video display apparatus further comprises means for executing a virtual video capture device. The virtual video capture device is configured to retrieve the image data. The virtual video capture device is further configured to transcode the retrieved image data. The virtual video capture device is configured output the transcoded image data for use by the program. The video display apparatus further comprises means for registering the virtual video capture device as a first physical video capture device with an operating system, wherein the operating system controls execution of the program.

Another embodiment of the disclosure provides a computer program product for processing data for a program configured to receive video input from at least one physical video capture device. The computer program product comprises a non-transitory computer-readable medium. The non-transitory computer-readable medium has stored thereon code for causing a computer to execute a program that is configured to receive video input from at least one physical video capture device. The non-transitory computer-readable medium further has stored thereon code for causing a computer to execute a virtual video capture device. The virtual video capture device is configured to cause the computer to retrieve the image data. The virtual video capture device is further configured to cause the computer to transcode the retrieved image data. The virtual video capture device is further configured to cause the computer to output the transcoded image data for use by the program. The non-transitory computer-readable medium further has stored thereon code for causing a computer to register the virtual video capture device as a first physical video capture device with an operating system, wherein the operating system controls execution of the program.

### BRIEF DESCRIPTION OF THE DRAWINGS

FIG. 1A illustrates an exemplary computing device.

FIG. 1B illustrates another exemplary computing device.

FIG. 2 is a functional block diagram of a computing device.

FIG. 3 is a functional block diagram of a video capture device.

FIG. 4 is a functional block diagram of a computing system with a virtual video capture device.

FIG. 5 is an exemplary user interface for controlling a virtual video capture device driver.

FIG. 6 is a flowchart of an exemplary process for capturing video via an auxiliary input of a video capture device.

FIG. 7 is a flowchart of an exemplary process for installing a virtual video capture device and transmitting video data.

FIG. 8 is a flowchart of an exemplary process for transcoding image data in a virtual video capture device.

FIG. 9 is a flowchart of an exemplary process of obtaining image data by a virtual video capture device from an operating system.

FIG. 10 is a flowchart of another exemplary process of obtaining image data by a virtual video capture device from an operating system.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. The following description is presented to enable any person skilled in the art to make and use the invention. Details are set forth in the following description for purpose of explanation. It should be appreciated that one of ordinary skill in the art would realize that the invention may be practiced without the use of these specific details. In other instances, well known structures and processes are not elaborated in order not to obscure the description of the invention with unnecessary details. Thus, the present invention is not intended to be limited by the embodiments shown, but is to be accorded with the widest scope consistent with the principles and features disclosed herein.

The systems and methods described herein relate to implementing a virtual video capture device. In one embodiment, the virtual video capture device is a virtual device running on a computing system that appears to the system as a physical camera such as a webcam. Like a webcam, the virtual video capture device outputs video data that may be used by applications running on the computing system, such as video chat applications. However, unlike a webcam, the virtual video capture device does not necessarily physically capture images through a sensor of a camera, but rather outputs video from a variety of different sources in a format that is similar to a physical camera's output. For example, the virtual video capture device may take a video file residing on a computer and format it into the output format used by a physical camera. An application may then use this output from the virtual video capture device. This allows, for example, a video chat application that expects an input from a physical camera to instead receive input from different sources via the virtual video capture device. Previously such applications needed to be altered or redesigned in order to accept input from sources other than a physical camera. However, using the teachings described herein, such applications can receive input from additional sources without requiring alteration or redesign.

The systems and methods described herein further relate to a video capture device such as a network camera with an auxiliary input. This allows a network camera to receive an auxiliary video input from a source other than the sensor of the network camera, and share the hardware and/or software resources of the network camera to encode, format, and transmit the input video over a network connection. Previously, if a user desired to share images our audio through a network camera from an auxiliary source, such as a DVD player, the user could not do so as the network camera is only configured to receive input via the sensors built into the network camera. However, using the teachings described herein, a user could feed the images or audio from the auxiliary source into the auxiliary input of the network camera for sharing.

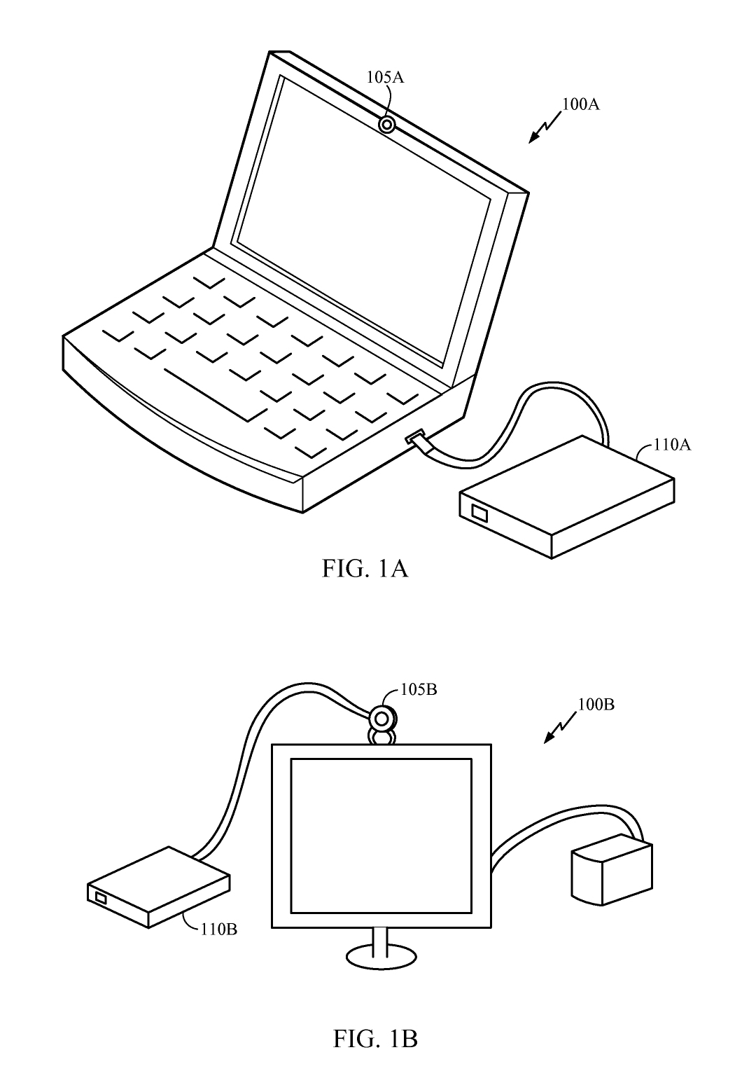

FIG. 1A illustrates an exemplary computing device that may be used with embodiments described herein. The computing device 100a may be any well known computing system. Examples of well known computing systems, environments, and/or configurations include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like. As shown, the computing device 100a includes a camera 105a. The camera 105a is shown as an integrated camera built into the housing of the computing device 100a. The camera 105a may comprise a video capture device such as a webcam. Further, a video source 110a is attached to the computing device 100a. The video source 110a may comprise any video source such as a DVD player, a blu-ray player, a camcorder, etc. The video source 110a may be connected to the computing device 100a via an interface on the computing device 100a. The port may comprise at least one of a USB, DVI, VGA, component video, etc.

FIG. 1B illustrates another exemplary computing device that may be used with embodiments described herein. The computing device 100b may also be any well known computing system. As shown the computing device 100b includes a camera 105b. The camera 105b is shown as an external camera that connects to the computing device 100b. The camera 105b connects to the computing device 100b via a USB interface. The camera 105b may comprise a video capture device such as a webcam. Further, a video source 110b is attached to the camera 105b. The video source 110b may comprise any video source such as a DVD player, a blu-ray player, a camcorder, etc. The video source 110b may be connected to the camera 105b via an interface on the camera 105b. The interface may comprise at least one of a USB, DVI, VGA, component video, etc.

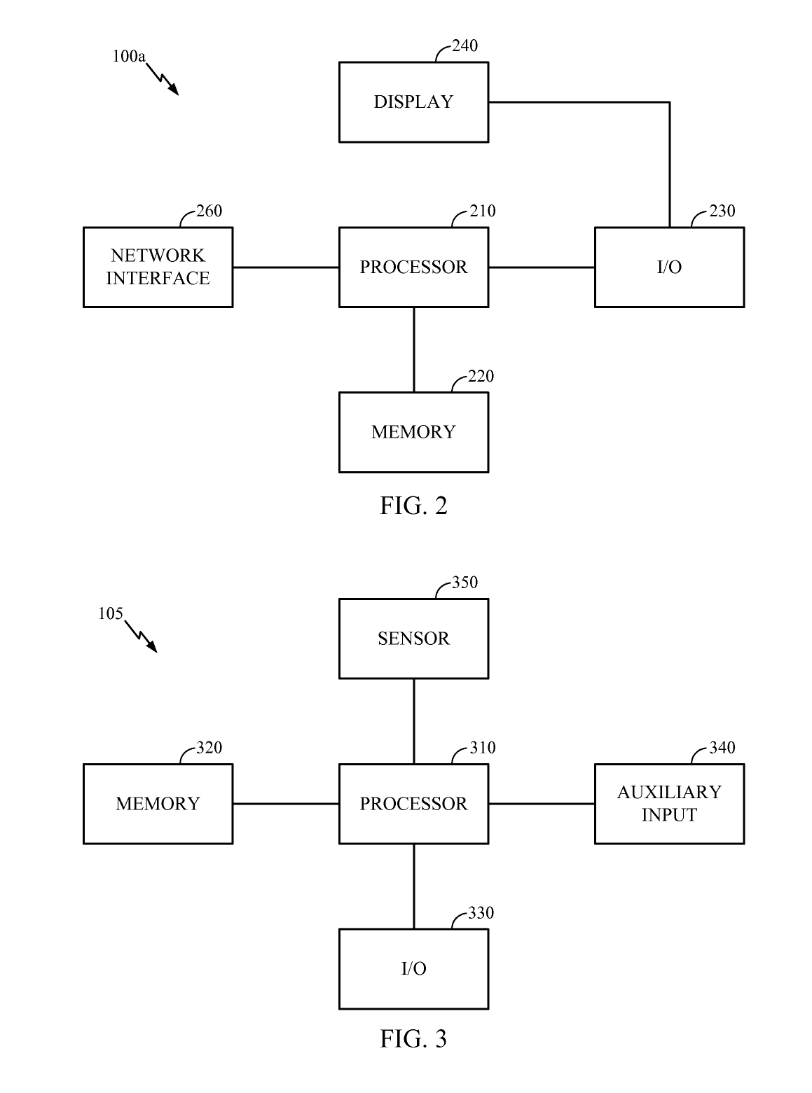

FIG. 2 is a functional block diagram of a computing device. The computing device 100 may correspond to any one of computing device 100a, computing device 100b, or another similar computing device. The computing device 100 includes a processor 210 in data communication with a memory 220, and an input/output interface 230. The input/output interface 230 is further in data communication with a display 240. The processor 210 is further in data communication with a network interface 260. Although described separately, it is to be appreciated that functional blocks described with respect to the computing device 100 need not be separate structural elements. For example, the processor 210 and memory 220 may be embodied in a single chip. Similarly, two or more of the processor 210, and network interface 260 may be embodied in a single chip.

The processor 210 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The processor 210 can be coupled, via one or more buses, to read information from or write information to memory 220. The processor may additionally, or in the alternative, contain memory, such as processor registers. The memory 220 can include processor cache, including a multi-level hierarchical cache in which different levels have different capacities and access speeds. The memory 220 can also include random access memory (RAM), other volatile storage devices, or non-volatile storage devices. The storage can include hard drives, optical discs, such as compact discs (CDs) or digital video discs (DVDs), flash memory, floppy discs, magnetic tape, and Zip drives.

The processor 210 is also coupled to an input/output interface 230 for, receiving input from and providing output to, devices connected to the computing device 100. Examples of such devices include, but are not limited to, a keyboard, buttons, keys, switches, a pointing device, a mouse, a joystick, a remote control, an infrared detector, a video camera (e.g., a webcam), a DVD player, a Blu-ray player, a motion detector, a microphone (possibly coupled to audio processing software to, e.g., detect voice commands) visual output devices (e.g., display 240), including displays and printers, audio output devices, including speakers, headphones, earphones, and alarms, and haptic output devices, including force-feedback game controllers and vibrating devices.

The processor 210 is further coupled to a network interface 260. The network interface 260 may comprise one or more modems. The network interface 260 prepares data generated by the processor 210 for transmission to a network. The transceiver 260 also demodulates data received via the network. The network interface 260 can include a transmitter, receiver, or both. In other embodiments, the transmitter and receiver are two separate components. The network interface 260, can be embodied as a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein.

FIG. 3 is a functional block diagram of a video capture device. The video capture device 105 may correspond to any one of the camera 105a, camera 105b, or another similar video capture device. The video capture device 105 includes a processor 310 in data communication with a memory 320, and an input/output interface 330. The processor 310 is further in data communication with an auxiliary input 340 and a sensor 350. Although described separately, it is to be appreciated that functional blocks described with respect to the video capture device 105 need not be separate structural elements. For example, the processor 310 and memory 320 may be embodied in a single chip.

The processor 310 can be a general purpose processor, a digital signal processor (DSP), an application specific integrated circuit (ASIC), a field programmable gate array (FPGA) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

The processor 310 can be coupled, via one or more buses, to read information from or write information to memory 320. The processor may additionally, or in the alternative, contain memory, such as processor registers. The memory 320 can include processor cache, including a multi-level hierarchical cache in which different levels have different capacities and access speeds. The memory 320 can also include random access memory (RAM), other volatile storage devices, or non-volatile storage devices. The storage can include hard drives, optical discs, such as compact discs (CDs) or digital video discs (DVDs), flash memory, floppy discs, magnetic tape, and Zip drives.

The processor 310 is also coupled to an input/output interface 330 for, receiving input from and providing output to a computing device such as the computing device 100. The input/output interface 330 may comprise a USB interface, a FireWire interface, etc.

The processor 310 is also coupled to an auxiliary input 340 for, receiving input from a video source (e.g., video source 110a/110b) such as a DVD player, a blu-ray player, a camcorder, etc. The auxiliary input 340 may comprise an input interface such as DVI, HDMI, VGA, RCA, component video, etc.

The processor 310 is also coupled to a sensor 350 for, capturing images/video. The sensor 350 may comprise a CCD, CMOS, or other suitable type of sensor.

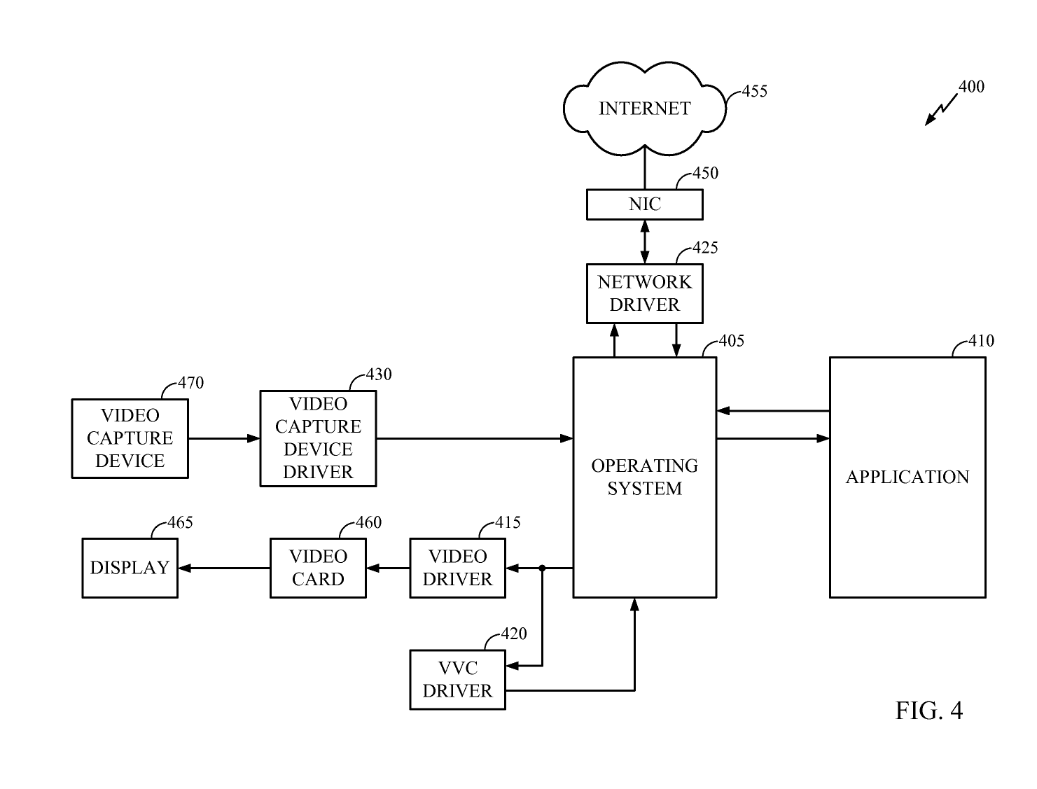

FIG. 4 is a functional block diagram of a computing system with a virtual video capture device. The system 400 includes an operating system 405, an application 410, a video driver 415, a virtual capture device driver 420, a network driver 425, and a camera driver 430, which may individually or collectively comprise one or more software modules that may be stored in a memory and executed by a processor such as the memory 220 and the processor 210 of the computing device 100.

The application 410 may comprise a video application such as Skype, Windows Live Messenger, GChat, etc. The application 410 is configured to receive video data from a standard video capture device, e.g. driver. In particular, the application 410 may be configured to receive video data from a camera driver for a webcam.

The network driver 425 may be configured to receive input from a network interface card (NIC) 450, which may further be configured to communicate with a network such as an Internet Protocol network such as the Internet 455. For example, the operating system 405 may function to facilitate execution of the application 410. The application 410 may generate video data and interact with the operating system 405, such as through APIs, to transmit the video data over the Internet 455 to another device connected to the Internet 455. The operating system 405 may send the video data to the network driver 425, which controls the NIC 450 to transmit the data over the Internet 455. Similarly, the NIC 450, network driver 425, operating system 405, and application 410 may function to receive video from the Internet 455 at for example the application 410.

The video driver 415 may be configured to communicate with a video card 460, which further communicates with a display 465. For example, the application 410 may receive or generate video data for display on the display 465. The application 410 may interact with the operating system 405, such as through APIs, to display the video data on the display 465. The operating system 405 may send the video data to the video driver 415, which controls the video card 460 to transmit video data to the display 465. The display 465 then displays the video data.

The video capture device driver 430 may be configured to communicate with a video capture device 470, e.g., video capture device 105. For example, the application 410 may capture video data through the video capture device 470. The application 410 may interact with the operating system 405, such as through APIs, to capture the video data. The operating system 405 may utilize the video capture device driver 430 to communicate with the video capture device 470 and receive video from the video capture device 470, such as video from a sensor on the video capture device 470, or video from an auxiliary input on the video capture device 470. The operating system 405 may then direct the received video to the application 410.

Utilizing the various modules/components of the system 400 described above, the system 400 may capture video data, display the video data on a display, and further transmit the video data to another device over the Internet. The system 400 may further be configured to receive video data from other sources than the video capture device 460. As discussed above, the application 410 is configured to receive video data from a standard video capture device through a standard video capture device driver. Accordingly, the virtual video capture (VVC) driver 420 is configured to act as a standard video capture device driver that captures video from sources other than a standard video capture device. The VVC driver 420 formats the video data received from such a source in a format that is the same as a standard video capture device. The source, which appears to the application 410 as a as a standard video capture device due to the function of the VVC driver 420, is referred to as a “virtual video capture device.”

In one embodiment, the virtual video capture device comprises a video source such as a DVD player, a blu-ray player, a camcorder, etc. that communicates through the input/output interface 230 of the computing device 100. In another embodiment, the virtual video capture device comprises a video source that communicates through an auxiliary input (e.g., auxiliary input 340) of the video capture device 460.

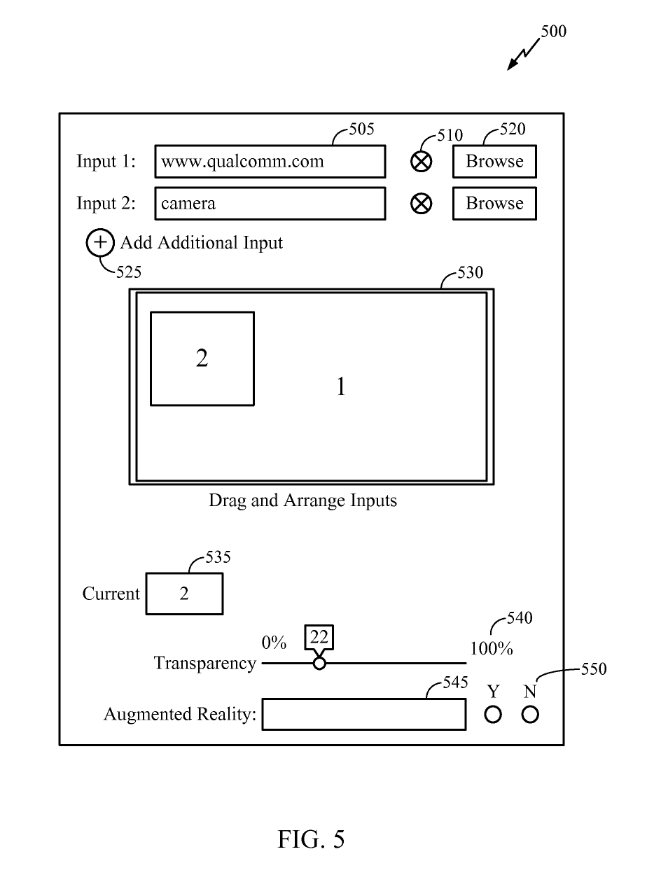

In yet another embodiment, the virtual video capture device comprises images being output to the display 465. For example, one or more images may be output to the display 465 via the video driver 415 and the video card 460. The images may be displayed in one or more “windows” such as windows seen in operating systems such as OS X, Windows, etc. The images may comprise, for example, video data from a video program such as Windows Media Player, iTunes, QuickTime Player, Adobe Flash Player, etc., or some other image data such as a display from a word editing program, web browser, Adobe Acrobat, etc. In this embodiment, the VVC driver 420 is configured to interact with the operating system to receive image data that is being output to the video driver 415. The VVC driver 420 may receive all images being output to the display 465, or just a portion of the images. The VVC driver 420 further formats the image data into the same format output by a standard video capture device driver. The formatted image data may be then utilized by the application 410. FIGS. 5-9 further expand on the functionality of the VVC driver 420 and the system 400.

In yet another embodiment, the virtual video capture device comprises a file such as an image file, a video file, an Adobe Acrobat file, a web page, etc.

The virtual video capture device may further comprise a combination of one or more of the virtual video capture devices described above and/or the video capture device 470. For example, the VVC driver 420 may be configured to receive image data from the video capture device driver 430 via the operating system 405. The VVC driver 420 may further be configured to overlay input from another source discussed above such as images being output to the display 465, a file, another video source, etc., on top of the image data from the video capture device driver 430. The images may be overlapped, have different degrees of transparency, arranged in a split screen format, etc. Further, two or more of the various virtual video capture devices and/or video capture devices may be combined as discussed. Selection of the virtual video capture that is to be used for output of the VVC driver 420 may be made by way of a user interface such as the one described below with respect to FIG. 5.

The VVC driver 420 may further be configured to interact with the operating system 405 to incorporate augmented reality features to the images of the virtual video capture device. For example, the VVC driver 420 may be configured to overlay augmented reality information from a file, web source, or other source that adds information describing an image of the virtual video capture device overlayed on the image.

FIG. 5 is an exemplary user interface for controlling a virtual video capture device driver of FIG. 4. The user interface 500 may be displayed on the display 465 of the system 400. The user interface 500 may be controlled using a keyboard, mouse, and or other input system as is known in the art. The user interface 500 includes one or more input boxes 505 for selecting which input should be selected by the VVC driver 420. The input boxes 505 may comprise drop down boxes, and or text input boxes. As shown in FIG. 4, the first input comprises a web address and the second input comprises the video capture device 470. The user interface 500 further comprises removal buttons 510 associated with each input. Selecting a removal button 510 causes the associated input to be removed from the output of the VVC driver 420. Each input is further associated with a browse button 520. Selecting the browse button 530 opens a dialog box allowing a user to search for a file or particular input to use as an input. The user interface 500 further comprises an add button 525. The add button 525 adds an additional input with an associated input box 505, removal button 510, and browse button 520.

The user interface 500 further comprises a preview frame 530. The preview frame 530 displays a view of the output of the VVC driver 420 based on the user selections made in the user interface 500. As shown, input 1 is shown as taking the entire frame as input window 1, while input 2 is overlayed on top of input 1 as input window 2. A user may resize and move the inputs by selecting and moving the input window, or selecting a side or corner of the input window and resizing the input window as is known in the art. Further, a current selection box 535 shows the input window that is currently selected. The transparency level of a particular input can be changed by using a transparency input 540. The input shown in the current selection box 535 is the input that is changed when using the transparency input 540. Further, a user may add or remove augmented reality information to an input by selecting whether to ‘Y’ add the information or ‘N’ remove the information using selection buttons 550. The file or source of the augmented reality information can be input in the input box 545. The input shown in the current selection box 535 is the input that is changed using the augmented reality selection buttons 550 and the current selection box 535.

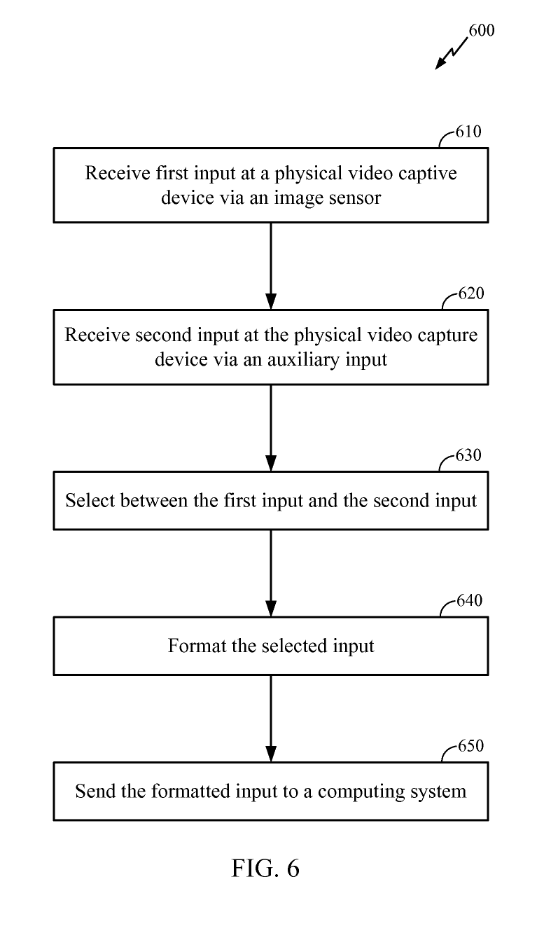

FIG. 6 is a flowchart of an exemplary process for capturing video via an auxiliary input of a video capture device. As described above, with respect to FIG. 1B, a video capture device may have an auxiliary input for receiving image data from an external source besides the sensor of the video capture device. The process 600 describes how such input is output to the application 410 for transmission. At a first step 610, the system 400 receives a first input at the video capture device 470 via an image sensor of the video capture device 470. At a next step 620, the video capture device 470 receives a second input at an auxiliary input port of the video capture device 470. Continuing at a step 630, at least one of the first input and the second input are selected for output. For example, the video capture device 470 may have a physical switch to select the input. In another embodiment, the application 410 may interact with the operating system 405 and the video capture device driver 430 to select the input. Further, at a step 640, the video capture device 470 formats the selected input to a video format utilized by the application 410. Next, at the step 650, the video capture device 470 outputs the formatted input to the video capture device 430, which sends the input to the application 410 via the operating system 405.

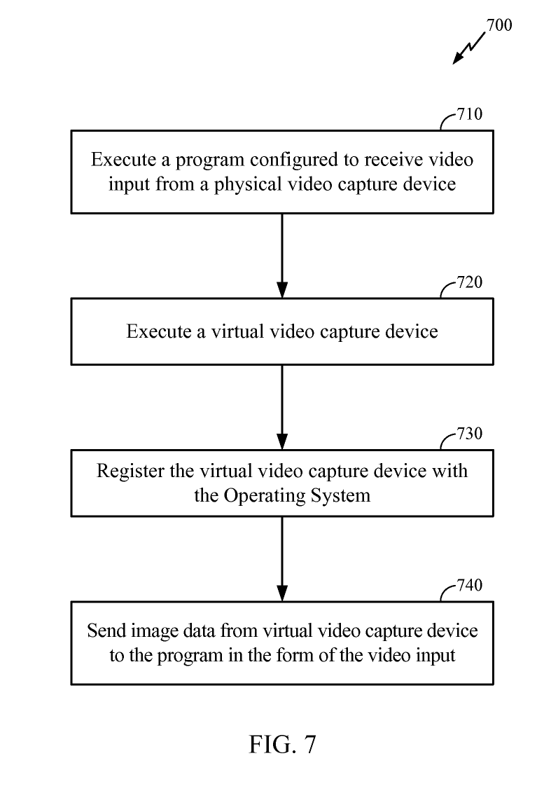

FIG. 7 is a flowchart of an exemplary process for installing a virtual video capture device and transmitting video data. As described above, with respect to FIG. 4, a virtual video capture device may interact with the operating system 405 and the application 410 to provide video data for transmission. Accordingly, a VVC driver 420 needs to be installed and setup on the system 400. The process 700 describes how the VVC driver 420 is setup. At a step 710, the system 400 executes a program (e.g., application 410) configured to receive video input from a physical video capture device (e.g., video capture device 470). Continuing at a step 720, the system 400 executes a video capture device application that is configured to receive image data from a source such as display data, and output the data in the same format as a physical video capture device. At the step 730, the virtual video capture device is registered with the operating system 405. Accordingly, a VVC driver 420 is setup for the virtual video capture device. Further, at the step 740, the VVC driver 420 outputs image data to the application 410 in the same format as a physical video capture device.

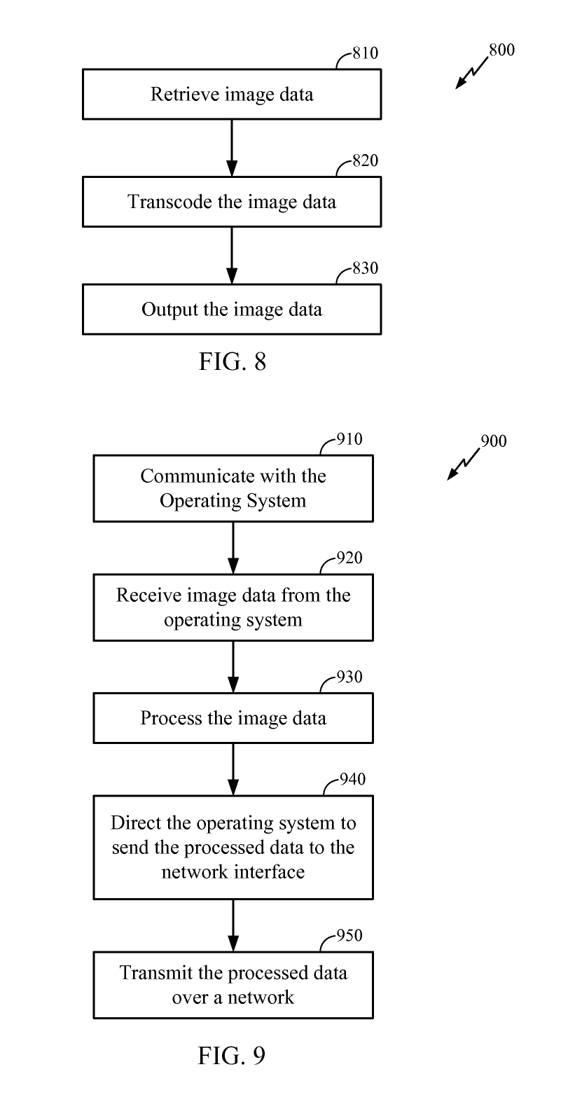

FIG. 8 is a flowchart of an exemplary process for transcoding image data in a virtual video capture device. As discussed above with respect to FIG. 4, image data input into the VVC driver 420 should be formatted into the format used by a video capture device so that the video is compatible with the application 410. Accordingly, after setup of the VVC driver 420 according to process 700, image data needs to be transcoded into the proper format as discussed in a process 800. At a step 810, the VVC driver 420 retrieves image data. For example, the VVC driver 420 retrieves at least a portion of the image data send to the video driver 415 for display on the display 465. Continuing at a step 820, the VVC driver 420 transcodes the retrieved image data into a format that is the same as a physical video capture device (e.g., video capture device 470). As discussed above with respect to FIGS. 4 and 5, the VVC driver 420 may retrieve image data from multiple sources. Accordingly, the VVC driver 420, as discussed above, may further format the image data from multiple sources into a single image data for output. Control of how the image data from multiple sources is put together into a single image data for output is controlled, for example, by a user interface such as the user interface 500 discussed above with respect to FIG. 5. Further, at a step 830, the VVC driver 420 outputs the transcoded image data for use by the operating system 405 and the application 410.

FIG. 9 is a flowchart of an exemplary process of obtaining image data by a virtual video capture device from an operating system. As discussed above with respect to FIG. 4, the application 410 receives image data from the VVC driver 420 for transmission to the Internet 455. Process 900 describes how the image data is received from the VVC driver 420 and is output over a network. At a step 910, the application 410 communicates with the operating system 405 to retrieve image data from the VVC driver 420. Next, at a step 920, the application 410 receives the image data from the operating system 405, which receives the image data from the VVC driver 420. Continuing at a step 930, the application 410 processes the image data for communication to another device. Further at the step 940, the application 410 directs the operating system 405 to send the processed data to the network driver 425 for transfer over the Internet 455. Continuing at the step 950, the network driver 235 transmits the processed data over a network (e.g., the Internet 455) via the network interface card 450.

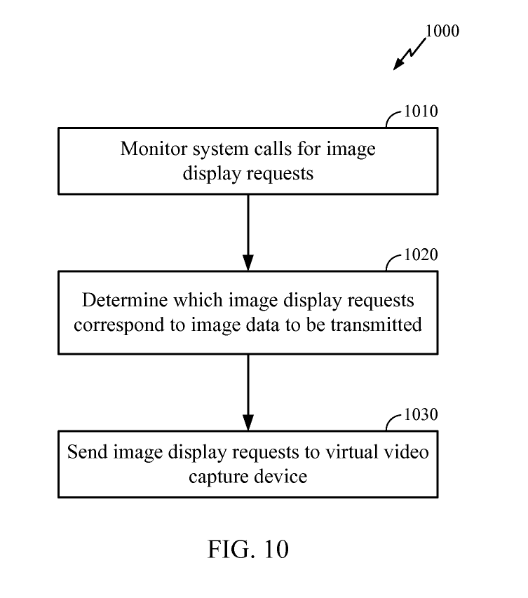

FIG. 10 is a flowchart of another exemplary process of obtaining image data by a virtual video capture device from an operating system. As discussed above with respect to FIG. 4, the VVC driver 420 may output video data that corresponds to images displayed on a display 465. The process 1000 described one embodiment of how the VVC driver 420 receives such images and outputs corresponding video data. At a step 1010, the VVC driver 420 monitors the system 400 for system calls from the operating system 405 and/or applications such as the application 410 for image display requests. For example, the VVC driver 420 monitors the system 400 for calls to send display data to the display 465 for display via the video driver 415. Continuing at a step 1020, the VVC driver 420 determines which image display requests correspond to image data to be transmitted to another device. For example, the VVC driver 420 may be configured to send image data corresponding to a particular file, window, etc. Further, at the step 1030, the VVC driver outputs the image display data in the same format as a video capture device.

One of ordinary skill in the art should understand that processes 600-1000 are merely illustrative. Steps of process 600-1000 may be removed, additional steps may be added, and/or the order of steps changed, while still being consistent with the principles and novel features disclosed herein.

The functionality described herein (e.g., with regard to one or more of the accompanying figures) may correspond in some aspects to similarly designated “means for” functionality in the appended claims. The functionality of the modules of FIGS. 2-4 may be implemented in various ways consistent with the teachings herein. In some aspects the functionality of these modules may be implemented as one or more electrical components. In some aspects the functionality of these blocks may be implemented as a processing system including one or more processor components. In some aspects the functionality of these modules may be implemented using, for example, at least a portion of one or more integrated circuits (e.g., an ASIC). As discussed herein, an integrated circuit may include a processor, software, other related components, or some combination thereof. The functionality of these modules also may be implemented in some other manner as taught herein.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of: A, B, or C” used in the description or the claims means “A or B or C or any combination of these elements.”

Those skilled in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art will further appreciate that the various illustrative logical blocks, modules, circuits, methods and algorithms described in connection with the examples disclosed herein may be implemented as electronic hardware, computer software, or combinations of both. To clearly illustrate this interchangeability of hardware and software, various illustrative components, blocks, modules, circuits, methods and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP communication, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor may read information from, and write information to, the storage medium. In the alternative, the storage medium may be integral to the processor. The processor and the storage medium may reside in an ASIC.

In one or more exemplary embodiments, the functions described may be implemented in hardware, software or firmware executed by a processor, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise non-transitory computer-readable storage media such as RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes flash memory storage, compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed examples is provided to enable any person skilled in the art to make or use the present invention. Various modifications to these examples will be readily apparent to those skilled in the art, and the generic principles defined herein may be applied to other examples without departing from the spirit or scope of the invention. Thus, the present invention is not intended to be limited to the examples shown herein but is to be accorded the widest scope consistent with the principles and novel features disclosed herein.

1. A video display apparatus comprising:
a processor; and
a memory in communication with the processor, the memory comprising instructions that when executed by the processor cause the processor to:
execute a program that is configured to receive video input from at least one physical video capture device;
execute a virtual video capture device, wherein the virtual video capture device is configured to:
retrieve the image data;
transcode the retrieved image data; and
output the transcoded image data for use by the program; and
register the virtual video capture device as a first physical video capture device with an operating system, wherein the operating system controls execution of the program.

2. The apparatus of claim 1, further comprising a second physical video capture device, wherein the memory further comprises instructions that when executed by the processor cause the processor to select between the program receiving the transcoded image data and video data from the second physical video capture device.

3. The apparatus of claim 2, wherein the second physical video capture device comprises a video camera.

4. The apparatus of claim 1, further comprising a network interface, wherein the program is configured to transmit the received video input over the network interface.

5. The apparatus of claim 4, wherein the network interface transmits the video input over the Internet.

6. The apparatus of claim 1, wherein the virtual video capture device is further configured to combine the image data with augmented data based on the image data.

7. The apparatus of claim 1, wherein the virtual video capture device comprises a device driver.

8. The apparatus of claim 1, wherein the memory further comprises instructions that when executed by the processor cause the processor to create a plurality of virtual video capture devices, wherein each virtual video capture device is associated with a particular portion of the image data.

9. The apparatus of claim 1, wherein a first portion of the image data, associated with a first virtual video capture device, comprises an application window.

10. The apparatus of claim 1, further comprising a display configured to display the image data.

11. A method of processing data for a program configured to receive video input from at least one physical video capture device, the method comprising:
executing a program that is configured to receive video input from at least one physical video capture device;
executing a virtual video capture device, wherein executing the virtual video capture device comprises:
retrieving the image data;
transcoding the retrieved image data; and
outputting the transcoded image data for use by the program; and
registering the virtual video capture device as a first physical video capture device with an operating system, wherein the operating system controls execution of the program.

12. The method of claim 11, further comprising selecting between the program receiving the transcoded image data and video data from a second physical video capture device.

13. The method of claim 12, wherein the second physical video capture device comprises a video camera.

14. The method of claim 11, further comprising transmitting the received video input over a network.

15. The method of claim 14, wherein the network comprises the Internet.

16. The method of claim 11, wherein the virtual video capture device is further configured to combine the image data with augmented data based on the image data.

17. The method of claim 11, wherein the virtual video capture device comprises a device driver.

18. The method of claim 11, further comprising creating a plurality of virtual video capture devices, wherein each virtual video capture device is associated with a particular portion of the image data.

19. The method of claim 11, wherein a first portion of the image data, associated with a first virtual video capture device, comprises an application window.

20. The method of claim 11, further comprising displaying the image data.

21. A video display apparatus comprising:
means for executing a program that is configured to receive video input from at least one physical video capture device;
means for executing a virtual video capture device, wherein the virtual video capture device is configured to:
retrieve the image data;
transcode the retrieved image data; and
output the transcoded image data for use by the program; and
means for registering the virtual video capture device as a first physical video capture device with an operating system, wherein the operating system controls execution of the program.

22. The apparatus of claim 21, further comprising means for selecting between the program receiving the transcoded image data and video data from a second physical video capture device.

23. The apparatus of claim 22, wherein the second physical video capture device comprises a video camera.

24. The apparatus of claim 21, further comprising means for transmitting the received video input over a network.

25. The apparatus of claim 24, wherein the network comprises the Internet.

26. The apparatus of claim 21, wherein the virtual video capture device is further configured to combine the image data with augmented data based on the image data.

27. The apparatus of claim 21, wherein the virtual video capture device comprises a device driver.

28. The apparatus of claim 21, further comprising means for creating a plurality of virtual video capture devices, wherein each virtual video capture device is associated with a particular portion of the image data.

29. The apparatus of claim 21, wherein a first portion of the image data, associated with a first virtual video capture device, comprises an application window.

30. The apparatus of claim 21, further comprising means for displaying the image data.

31. A computer program product for processing data for a program configured to receive video input from at least one physical video capture device, the computer program product comprising:
a non-transitory computer-readable medium having stored thereon:
code for causing a computer to execute a program that is configured to receive video input from at least one physical video capture device;
code for causing a computer to execute a virtual video capture device, wherein the virtual video capture device is configured to cause the computer to:
retrieve the image data;
transcode the retrieved image data; and
output the transcoded image data for use by the program; and
code for causing a computer to register the virtual video capture device as a first physical video capture device with an operating system, wherein the operating system controls execution of the program.

32. The computer program product of claim 31, wherein the non-transitory computer-readable medium further has stored thereon code for causing a computer to select between the program receiving the transcoded image data and video data from a second physical video capture device.

33. The computer program product of claim 32, wherein the second physical video capture device comprises a video camera.

34. The computer program product of claim 31, wherein the non-transitory computer-readable medium further has stored thereon code for causing a computer to transmit the received video input over a network.

35. The computer program product of claim 34, wherein the network comprises the Internet.

36. The computer program product of claim 31, wherein the virtual video capture device is further configured to combine the image data with augmented data based on the image data.

37. The computer program product of claim 31, wherein the virtual video capture device comprises a device driver.

38. The computer program product of claim 31, wherein the non-transitory computer-readable medium further has stored thereon code for causing a computer to create a plurality of virtual video capture devices, wherein each virtual video capture device is associated with a particular portion of the image data.

39. The computer program product of claim 31, wherein a first portion of the image data, associated with a first virtual video capture device, comprises an application window.

40. The computer program product of claim 31, wherein the non-transitory computer-readable medium further has stored thereon code for causing a computer to display the image data.
